(19) United States
(12) Patent Application Publication
(10) Pub. No.: US 2003/0150198 A1
(43) Pub. Date: Aug. 14, 2003

(54) Filterless folded and ripple dust separators and vacuum cleaners using the same

(76) Inventors: Lewis Illingworth, Kensington, NH (US); David Reinfeld, Englewood, NJ (US)

Correspondence Address: Ward & Olivo, Suite 300, 382 Springfield Avenue, Summit, NJ, 07901, US

(21) Appl. No.: 10/370,034

(22) Filed: Feb. 19, 2003

Related U.S. Application Data
(63) Continuation-in-part of application No. 10/318,320, filed on Dec. 12, 2002.
(63) Continuation-in-part of application No. 10/025,376, filed on Dec. 19, 2001.
Application No. 10/025,376 is a continuation-in-part of application No. 09/835,084, filed on Apr. 13, 2001.
Application No. 09/835,084 is a continuation-in-part of application No. 09/829,416, filed on Apr. 9, 2001.
Application No. 09/829,416 is a continuation-in-part of application No. 09/728,602, filed on Dec. 1, 2000.
Application No. 09/728,602 is a continuation-in-part of application No. 09/316,318, filed on May 21, 1999.

(51) Int. Cl. B01D 45/00

(52) U.S. Cl. 55/406; 55/428; 55/467; 95/272; 95/267; 55/444; 55/445

(57) ABSTRACT

The present invention is directed to the separation of dust and debris from flowing fluid. Conventional cyclone separators and centrifugal separators present a tradeoff between the extent of dust separation and the cross-sectional area of fluid flow. Thus, increased flow capacity cannot be achieved without reducing the amount of dust removal. In contrast, the present invention allows for the increase of cross-sectional flow area without jeopardizing dust removal. The apparatus is designed such that the cross-sectional area of fluid flow can be increased independently of the radii of curvature of the redirections. Therefore, dust is still effectively removed while the flow capacity of the system is increased. Also included herein are embodiments utilizing these concepts of dust separation vacuum cleaner embodiments.

### CROSS REFERENCE TO OTHER APPLICATIONS

This application is filed as a continuation-in-part of co-pending application entitled “Axial Flow Centrifugal Dust Separator,” filed Dec. 12, 2002, which is a continuation-in-part of co-pending application Ser. No. 10/025,376 entitled “Toroidal Vortex Bagless Vacuum Cleaner Centrifugal Dust Separator,” filed Dec. 19, 2001, which is a continuation-in-part of co-pending application Ser. No. 09/835,084 entitled “Toroidal Vortex Bagless Vacuum Cleaner,” filed Apr. 13, 2001, which is a continuation-in-part of co-pending application Ser. No. 09/829,416 entitled “Toroidal and Compound Vortex Attractor,” filed Apr. 9, 2001, which is a continuation-in-part of co-pending application Ser. No. 09/728,602, filed Dec. 1, 2000, entitled “Lifting Platform,” which is a continuation-in-part of co-pending Ser. No. 09/316,318, filed May 21, 1999, entitled “Vortex Attractor.”

### TECHNICAL FIELD OF THE INVENTION

The present invention relates to the separation of dust and debris from fluid flow, and more specifically, to an improved dust separator that utilizes centripetal forces to separate fine particulates from a fluid stream. Also disclosed herein are embodiments utilizing dust separators of the present invention in vacuum cleaner applications.

### BACKGROUND OF THE INVENTION

Dust separation is achieved in the art by various means including filters, Lamella separators, deflection separators, cyclonic separators, etc. For instance, side and top plan views of typical cyclonic dust separator design 100 are depicted in FIGS. 1A and 1B, respectively. Here dusty air 101 enters tangentially at the top of cyclonic dust separator 100. Dusty air 101 then spirals downward along conical wall 102, indicated by flow lines 103. While dusty air 101 spirals downward, dust particles 106 are ejected tangentially against conical wall 102. The downward component of airflow 103 carries dust 106 downward. Once airflow 103 reaches the bottom of cyclonic dust separator 100, airflow 103 is redirected upward. The curvature of airflow 103 prevents it from carrying dust 106 back upward. Ultimately, dust 106 is deposited at the bottom of conical dust separator 100. Finally, cleaned air 104 exits via pipe 105.

FIGS. 2A and 2B depict a side plan view of cylindrical vortex dust separator 200 which is fully disclosed in parent application entitled “Axial Flow Centrifugal Dust Separator,” filed Dec. 12, 2002, which is hereby incorporated herein by reference. Specifically, FIG. 2B indicates cross-section A-A of FIG. 2A. Dusty air 201 is drawn in by centrifugal pump impeller 202. Centrifugal pump impeller 202 spins air 201 at the rotational speed of centrifugal pump impeller 202 before propagating the air 201 outward. Airflow 203 then circulates downward along housing 204. Inertia throws dust outward such that it circulates around the inner wall of housing 204. Slot 206 is provided to allow dust 205 to enter collector box 207. In order to prevent dust from returning into circulating airflow 203, protective lip 210 is provided to prevent dust from exiting collector 207. Since a higher pressure is developed inside collector box 207 than within housing 204, cylindrical vortex airflow 203 is maintained without inhibiting heavier dust particles 206 from being expelled into collector box 207. As a result, substantially cleaned air 208 exits through pipe 209.

FIG. 3 depicts typical circulating airflow 301 within a cyclonic or centrifugal dust separator. Dust particle 302 within flow 301 has mass “m”, tangential speed “V”, and trajectory radius of curvature “R”. The inward, or centripetal, force necessary to maintain circular flow 301 of particle 302 is given by mV²/R. A lesser force could not hold particle 302 within its circular path and therefore, particle 302 would outwardly exit circular flow 301. Moreover, increasing the difference between mV²/R and the centripetal force (i.e., mV²/R-centripetal force) increases the rate at which dust particle 302 exits airflow 301. Thus, by maximizing mV²/R, the amount of dust that can be ejected from flow 301 is also maximized.

Unfortunately, when “R” is large (and thus, mV²/R is small), particle 302 travels slowly outward following spiral trajectory 401, as seen in FIG. 4. Accordingly, the number of revolutions necessary to effectively remove dust particle 302 from flow 301 depends positively on “R”. However, both cyclonic separator 100 of FIG. 1 and centrifugal separator 200 of FIG. 2 provide a limited number of revolutions before air exits. In order to ensure adequate dust removal, the overall flowrate of the system must be kept sufficiently low to ensure that dust particles are precipitated out. Fortunately, the present invention provides an apparatus that can accommodate larger flowrates without compromising dust removal.

In order to increase the overall flowrate while maintaining adequate dust removal in a cyclonic system, mV²/R must be increased. Since “m” is constant, either “V” must be increased or “R” must be decreased. In the case of cyclonic separator 100 of FIG. 1, “V” is the inherent speed of the airflow through the system, and thus, not easily increased. Any attempts at increasing “V” would result in higher power consumption. However, decreasing “R” reduces the cross-sectional area of the dust separator (i.e., area=nR²) and consequently limits the overall flowrate through the dust separator.

In the case of centrifugal separator 200 of FIG. 2, “V” can be increased, and also, the path length (i.e., the height of centrifugal separator 200 of FIG. 2) can be increased as described in parent application entitled “Axial Flow Centrifugal Dust Separator.” However, the goal of the present invention is to improve the performance of dust separators in which the airspeed is fixed by overall system requirements.

Thus, there is a clear need for a method and apparatus that effects simple, inexpensive, and efficient removal of dust, debris, or any other matter in a system which the flowrate is fixed by overall system requirements. The art is devoid of references that teach effective removal dust and debris in such a system. However, to fully understand the present invention in its proper context, reference is made to the following U.S. Patents: Parkinson U.S. Pat. No. 499,799 (hereinafter referred to as “Parkinson”); Wingrove U.S. Pat. No. 768,415 (hereinafter referred to as “Wingrove”); Greer et al. U.S. Pat. No. 4,159,942 (hereinafter referred to as “Greer”); Gustavsson et al. U.S. Pat. No. 4,227,903 (hereinafter referred to as “Gustavsson”); Monson et al. U.S. Pat. No. 4,323,369 (hereinafter referred to as “Monson”); Krambrock et al. U.S. Pat. No. 4,528,092 (hereinafter referred to as “Krambrock”); Michel-Kim U.S. Pat. No. 4,541,845 (hereinafter referred to as “Michel-Kim”); Richerson U.S. Pat. Nos. 4,927,437 and 4,973,341 (hereinafter referred to as the “Richerson” patents); Lehrmann U.S. Pat. No. 5,181,617 (hereinafter referred to as “Lehrmann”); Bone et al. U.S. Pat. No. 5,966,774 (hereinafter referred to as “Bone”); and Sandell U.S. Pat. No. 6,066,211 (hereinafter referred to as “Sandell”).

Parkinson discloses a dust separator that employs a series of S-shaped sheets around which air flows. When air passes through these sheets, a curved flow pattern that ejects dust is developed. The ejected dust then falls downward for removal. In contrast, the present invention operates independent of gravity, thereby functioning in any orientation.

Wingrove discloses an apparatus for separating oil from a nitrogen gas stream. Here, gas must pass in a zigzagged pattern through a series of folded plates. At each turn, the gas expels oil against the plates. Gravity then drains the oil downward for removal. However, the present invention, which operates independent of gravity, can separate matter from fluids in any orientation. Furthermore, the present invention provides a smoother flow than found within the folded plates of Wingrove.

Greer et al. discloses a device for separating particles in a fluid stream by size and/or density. Here the fluid stream is bent at 90° such that particulate matter is thrown outward. However, lighter particles are ejected slower than heavier particles. Thus, the ejection of lighter particles will occur further upstream than the ejection of heavier ones. Greer et al. provides a series of particle receptacles such that each receptacle will only capture particles within a certain size or density range. In contrast, the present invention provides means for preventing the separated matter from reentering fluid flow. Moreover, Greer et al. has some particulate flowing through the outlet. The instant invention, on the other hand, is capable of removing even fine particles from fluid flow.

Gustavsson et al. discloses an apparatus for cleaning gases. Upon entering the system, a wall of deflection separators removes coarse particles from the system. This occurs by deflecting airflow upward while the heavier debris collides with the deflection guides. Subsequently, the debris falls downward. Fine particles are later separated by a filter. Ultimately, Gustavsson et al. teaches an apparatus capable of separating large particles by deflection. However, a more efficient device that is capable of removing fine particles without a filter is preferable.

Monson et al. discloses an apparatus for cleaning particulate matter from air. Airflow originates from an annular duct. Then the airflow is redirected outward, and subsequently redirected inward. Upon the inward redirection, fluid partially exits through slits for removal while the remaining airflow continues onward. Because of the centrifugal effects of redirection, the outer part of airflow is dense in particulate matter. The particulate-dense fluid flow is then removed through the slits. It is preferable, however, to clean all fluid, and not eject a dirty stream of fluid. Thus, the instant invention can be configured to redirect fluid flow any number of times such that an arbitrarily large level of purity may be reached.

Krambrock et al. discloses an apparatus for separation of debris from airflow. Upon entering the system, dirty airflow is sent into an upper, tapered section which disperses the debris evenly throughout airflow. Then, the airflow is sent downward through an annular duct. Once the dirty airflow reaches the bottom of the annular duct, a second airflow deflects the dirty airflow upward. However, the heavier debris is not deflected and continues downward for removal. Thus, cleaned airflow is sent upward where it exits the apparatus. Yet, a simpler system not requiring a second airflow for deflection is preferred.

Michel-Kim discloses a separator utilizing a concentric nozzle design. The outermost annular duct formed within the concentric design provides dirty fluid. The flow is then redirected 180°, partially into an inner annular duct and partially into a central tubular duct. Thus, the fluid flow is split into two fractions after redirection. Because the particles are forced to the outside of the arcuate path during redirection, the fraction traveling through the central duct is dense in particulate matter. Conversely, the flow in the inner annular duct comprises substantially less particulate. It is preferable, however, to avoid the disposal of dirty fluid.

The Richerson patents disclose centrifugal separator designs utilizing a spiraling pathway formed between two spiral-shaped sheets. As air flows through this spiral pathway, airborne particles are thrown against the walls of the spiraling structure. Under the force of gravity, the expelled particles then fall down into a collection trough. Preferably, as in the present invention, the separator does not rely upon gravitational forces such that the separator can be implemented in any orientation. Furthermore, the present invention provides simpler structural design, thereby easing manufacture.

Lehrmann discloses a system for separating reclaimable material from a mixture. Therein, a pipe bent in a zig-zag configuration is used as a deflection sifter. A mixture of air and particulate material are sent upward through the sifter. The zig-zag configuration prevents larger particles from exiting the top outlet of the sifter. Consequently, they exit out of the bottom outlet of the sifter. The finer material, however, continues to travel with the airflow out of the top outlet of the sifter. Thus, the system is capable of separating fine material from heavier material. Yet, it is preferable to be able to separate both coarse and fine matter from the fluid flow.

Bone et al. teaches a hand-held vacuum cleaner comprising a snout that opens to remove debris from the filter. As in a conventional design, air is sucked through a nozzle, an input duct, and a filter. Air is subsequently expelled from the system. However, filters are inefficient, and it is preferable to avoid their use entirely.

Sandell discloses a vacuum cleaning system that draws air in through a nozzle, an elongated tube, a snout, a filter, and an impeller. Like other conventional portable vacuum cleaners, the Sandell system cleans air with a filter that is inefficient and prone to clogging.

Thus, there is a clear need in the art for a bagless, filterless dust separator that can effectively handle large flowrates and is capable of separating fine dust particles. Furthermore, a need exists for such filterless, bagless separators to be implemented into vacuum cleaning systems or any application that benefits from efficient cleaning of fluid flow.

### SUMMARY OF THE INVENTION

This application is an extension of and improvement upon matter disclosed in co-pending application entitled “Axial Flow Centrifugal Dust Separator,” filed Dec. 12, 2002, which is hereby incorporated herein by reference. This application extends from and advances upon technology from Applicant's invention disclosed in co-pending application Ser. No. 10/025,376 entitled “Toroidal Vortex Bagless Vacuum Cleaner Centrifugal Dust Separator,” filed Dec. 19, 2001, which is hereby incorporated herein by reference. Furthermore, the separator of this application is an improvement extending from technology disclosed in co-pending application Ser. No. 09/835,084 entitled “Toroidal Vortex Bagless Vacuum Cleaner,” filed Apr. 13, 2001, which is hereby incorporated herein by reference. Additionally, the bagless vacuum cleaner of this invention is an advancement extending from technology disclosed in the co-pending application Ser. No. 09/829,416 entitled “Toroidal and Compound Vortex Attractor,” filed Apr. 9, 2001, which is hereby incorporated herein by reference. The attractors disclosed therein improve upon technology extending from matter disclosed in co-pending application Ser. No. 09/728,602 entitled “Lifting Platform,” filed on Dec. 1, 2000, which is hereby incorporated herein by reference. Finally, the lifting platform technology is an extension advancing over technology disclosed in co-pending application Ser. No. 09/316,318 entitled “Vortex Attractor,” filed May 21, 1999, which is hereby incorporated herein by reference.

The present invention relates to dust separators that can handle large flow rates while maintaining a high degree of separation.

A dust separator of the present invention is preferably of a rectangular form. Like cyclonic and cylindrical vortex dust separators, the present invention separates particulate matter centrifugally. However, the flowrate through separators of the present invention may be arbitrarily large without sacrificing efficiency.

The layout of a separator of the present invention is preferably a rectangular parallelepiped. The flow through the separator generally follows a zigzagged pattern. Therefore, liquid will flow side to side (alternatively up and down, or in any other opposing directions) under the guidance of walls, partitions, or passages. Each time the fluid changes direction, dust and debris within the fluid flow are ejected by inertia. Therefore, fluid flow can be redirected an arbitrarily large number of times until the desired level of purity is obtained.

However, as discussed supra, the radius of curvature at which the fluid is redirected must be minimized in order to maximize efficiency. Cyclonic and cylindrical separators necessarily lose cross-sectional area (ΠR²) as radius of curvature R is decreased. On the other hand, the cross-sectional area of the present invention can be made arbitrarily large without increasing the radius of curvature. This is accomplished by increasing the width of the separator such that cross-sectional area is increased. The direction of the width increase is preferably orthogonal to the plane containing the vectors of overall flow direction and intermediate flow directions (i.e., the directions in which fluid flows between each redirection).

In the area of redirection, inefficient eddies may form. To reduce such parasitic fluid flow, collectors may be provided to collect debris each time fluid is redirected. The pressure within these collectors is preferably higher than within the flowing fluid, thereby maintaining the path of redirected fluid without inhibiting dust particles from traveling into the collectors. To further reduce parasitic fluid flow, baffles may be placed within the collectors. Also, because the amount of particles in the dirty fluid flow decrease with each redirection, the widths of slots leading into the collectors may decrease after each redirection. Furthermore, the slots leading into the collectors may comprise lips to prevent separated matter from reentering fluid flow. Alternatively, the collectors may comprise electrostatically charged members to attract dust and debris.

The present invention may also be implemented into vacuum cleaner embodiments, and more specifically disclosed herein, portable vacuum cleaners. The designs described infra intake fluid through a nozzle and a bendable rubber flap. Upon entry of fluid into the snout of the vacuum, fluid flow is redirected via “guide vanes,” such that dust and debris are centrifugally ejected into a collector. During the redirection, higher pressure is built-up within the collector than within the fluid flow. The resulting pressure differential helps maintain the curved path of redirected fluid flow without impeding the removal of dust and debris.

Also, baffles may be provided within the collector in order to prevent mixing of fluid in the collector and the fluid flow. This reduces the formation of eddies and further increases the efficiency of the system.

Once the dust and debris are removed, the fluid flows through a venturi and centrifugal pump before being expelled. As in the aforementioned separators related to the present invention, the flowrate capacity of the system may be increased without reducing its ability to separate dust and debris from the fluid flow. All other advantages of the separation system disclosed therein may also apply to the vacuum cleaners of the present invention.

Thus, it is an object of the present invention to provide a separator that is capable of separating large debris from fluid.

It is a further object of the present invention to provide a separator that is capable of separating fine debris, e.g., dust, from fluid.

It is yet another object of the present invention to provide a separator which has a large cross-sectional area and a small radius of curvature for ejecting particles.

Additionally, it is an object of the present invention to provide a collector for a separator that maintains fluid flow geometry via pressure differentials without jeopardizing dust and debris collection.

Furthermore, it is an object of the present invention to provide a separator that minimizes parasitic fluid flow.

Moreover, it is an object of the present invention to provide a separator capable of handling large flowrates.

It is yet another object of the present invention to provide a vacuum cleaner system which fulfills any or all objects of the present invention.

Thus, it is an object of the present invention to create a separator that may contain an arbitrary number of separation stages without substantially reconfiguring the device.

These and other objects will become readily apparent to one skilled in the art upon review of the following description, figures, and claims.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1A (FIG. 1A) (PRIOR ART) depicts a side plan view of a conventional cyclonic separator;

FIG. 1B (FIG. 1B) (PRIOR ART) depicts a top plan view of a conventional cyclonic separator;

FIG. 2A (FIG. 2A) (PRIOR ART) depicts a side plan view of a cylindrical vortex separator;

FIG. 2B (FIG. 2B) (PRIOR ART) depicts a cross-section of the cylindrical vortex separator of FIG. 2A;

FIG. 3 (FIG. 3) (PRIOR ART) depicts a typical flow path of the cyclonic and cylindrical vortex separators of FIGS. 1 and 2, respectively;

FIG. 4 (FIG. 4) (PRIOR ART) depicts a possible flow path of dust within the cyclonic and cylindrical vortex separators of FIGS. 1 and 2, respectively;

FIG. 5A (FIG. 5A) is a top plan view of an embodiment of the folded separator in accordance with the present invention;

FIG. 5B (FIG. 5B) is a side plan view of an embodiment of the folded separator in accordance with the present invention;

FIG. 6 (FIG. 6) is a plan view of an embodiment of the folded separator that illustrates parasitic fluid flow in accordance with the present invention;

FIG. 7 (FIG. 7) is a plan view of the embodiment of the folded separator including collectors in accordance with the present invention;

FIG. 8 (FIG. 8) is a plan view of a ripple flow separator in accordance with the present invention;

FIG. 9A (FIG. 9A) (PRIOR ART) depicts a vertical cross-section of a conventional, portable vacuum cleaner;

FIG. 9B (FIG. 9B) (PRIOR ART) depicts a horizontal cross-section of a conventional, portable vacuum cleaner;

FIG. 10 (FIG. 10) depicts a vertical cross-section of a portable vacuum cleaner with a single stage dust separator in accordance with the present invention;

FIG. 11 (FIG. 11) depicts a vertical cross-section of an alternate portable vacuum cleaner with a two-stage dust separator in accordance with the present invention;

FIG. 12 (FIG. 12) depicts a vertical cross-section of another alternate portable vacuum cleaner with a two-stage dust separator in accordance with the present invention;

FIG. 13 (FIG. 13) depicts a vertical cross-section of another alternate portable vacuum cleaner with a two-stage dust separator in accordance with the present invention;

FIG. 14 (FIG. 14) depicts a vertical cross-section of the preferred portable vacuum cleaner with a three-stage in accordance with the preferred vacuum cleaner embodiment of the present invention; and

FIG. 15 (FIG. 15) depicts the preferred ripple flow separator in accordance with the preferred embodiment of the present invention.

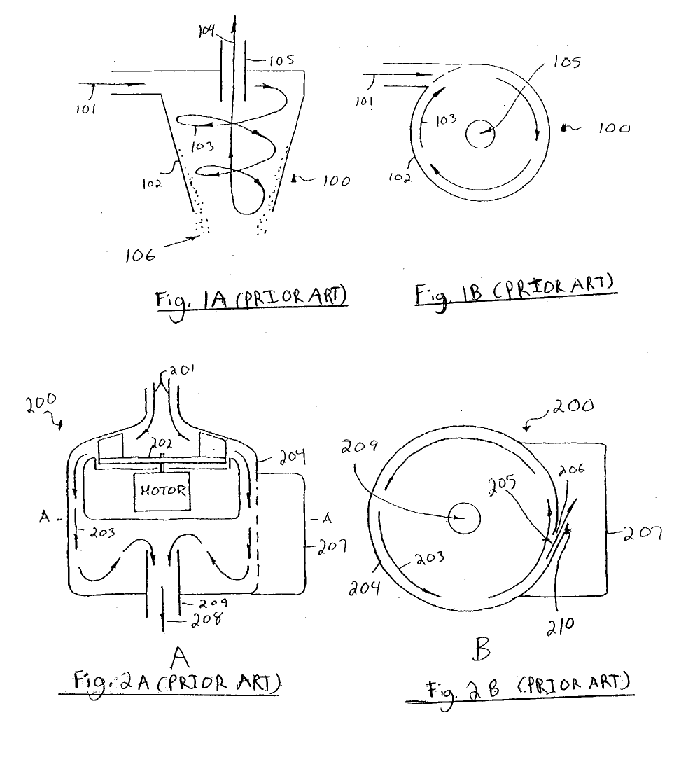

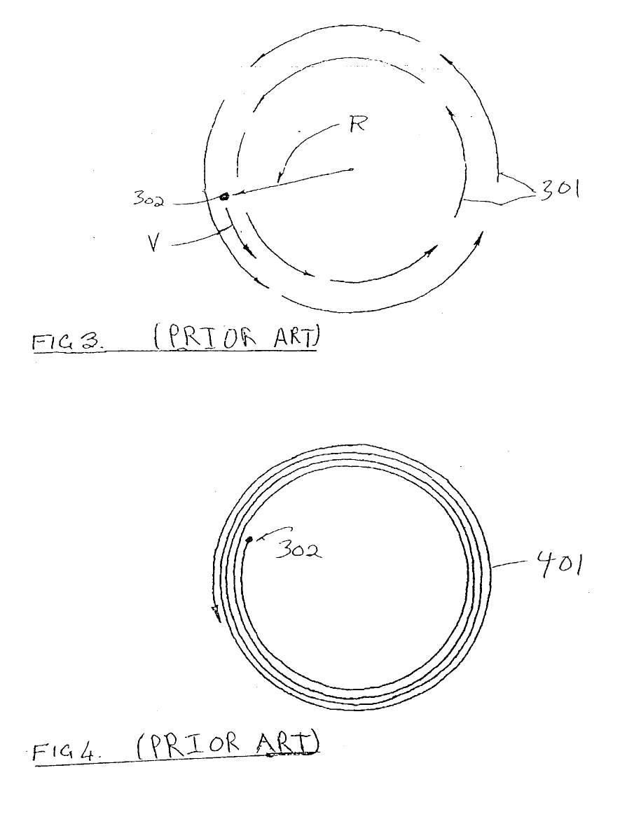

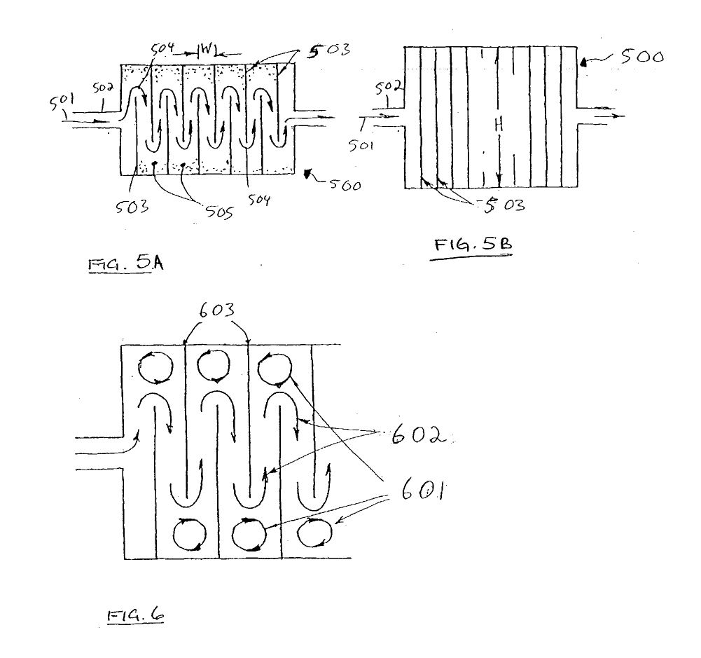

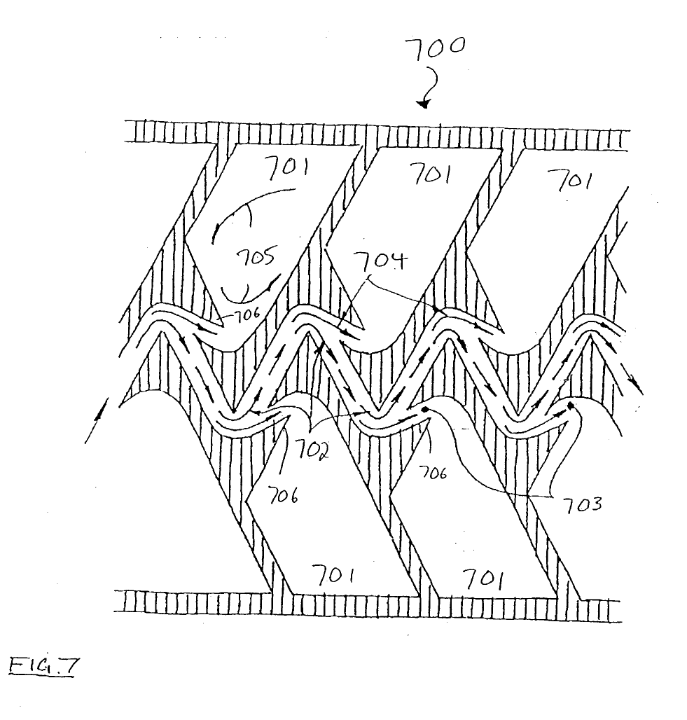

### DETAILED DESCRIPTION OF THE PREFERRED EMBODIMENTS

As required, detailed illustrative embodiments of the present invention are disclosed herein. However, techniques, systems, and operating structures in accordance with the present invention may be embodied in a wide variety of forms and modes, some of which may be quite different from those in the disclosed embodiments. Consequently, the specific structural and functional details disclosed herein are merely representative, yet in that regard, they are deemed to afford the best embodiments for purposes of disclosure and to provide a basis for the claims herein which define the scope of the present invention. The following presents a detailed description of a preferred embodiment (as well as some alternative embodiments) of the present invention and features thereof.

Certain terminology will be used in the following description for convenience in reference only and will not be limiting. The words “in” and “out” will refer to directions toward and away from, respectively, the geometric center of the device and designated and/or reference parts thereof. The words “up” and “down” will indicate directions relative to the horizontal and as depicted in the various figures. The words “clockwise” and “counterclockwise” will indicate rotation relative to a standard “right-handed” coordinate system. Such terminology will include the words above specifically mentioned, derivatives thereof, and words of similar import.

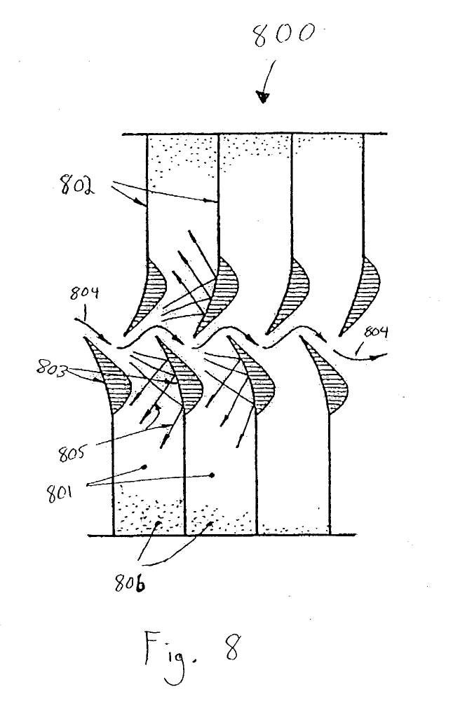

Generally, embodiments of the present invention are able to provide a large cross-sectional area without necessitating a large radius of curvature where particles are separated. Side plan and top plan views of separator 500 of the present invention are illustrated in FIGS. 5A and 5B, respectively. Note, however, the present invention can operate in any orientation independently from gravity. Consequently, the present invention does not have a true top or bottom. However, “top” and “side” are used only for exemplary purposes to aid in the understanding of the invention, and accordingly, do not limit the scope of the present invention. Here, dirty fluid 501 enters via inlet 502. Subsequently, fluid flows around a series of partitions 503 such that fluid flow 504 reverses direction repeatedly. As shown, fluid flow 504 exhibits small radii of curvature each time fluid flow 504 reverses direction. Because of the high mass of dust particles, dust 505 is deposited in the spaces in between partitions 503. In such a configuration, the cross-sectional area of fluid flow is defined by the product of spacing between partitions W multiplied by partition height H (i.e., area=W×H). Thus, the cross-sectional area can be increased by increasing H. Preferably, W is minimized such that the radii of curvature are also minimized. Consequently, large cross-sectional area can be achieved with small values of W, by making H sufficiently large. Hence, with a folded design, a single separator can be used to accommodate any flowrate. Consequently, accommodating larger flowrates with multiple separators in parallel is unnecessary. Further, the folded dust separator operates independent of gravity, and advantageously, functions in any orientation.

In cyclonic and centrifugal separators, fine dust particles require many revolutions to be ejected. In contrast, the folded design of the present invention can be readily extended to have an arbitrarily large number of sections. Heavy dust and dirt particles are thrown out of the fluid stream within the earlier fluid flow redirections. Subsequent sections may be added for the removal of increasingly finer dust particles.

In the folded separator of the present invention, eddies may form in the areas of redirection. These eddies may pick up dust and debris already removed from fluid flow. Furthermore, eddies may contribute to frictional losses within fluid flow. FIG. 6 shows where eddies 601 may form in the collection areas. Fluid flow 602 around the ends of partitions 603 induces vortex fluid flow (i.e., eddies 601) in the collecting areas. Eddies are generally found in dust separating systems that allow the dust collecting areas to remain open to the main fluid flow. Nevertheless, eddies can be eliminated by implementing baffles or separating the collecting area from the main fluid flow.

FIG. 7 shows a plan view of section 700 of such a folded separator comprising a series of collectors 701 connected to turning fluid flow 702 by slots 703. These slots 703 prevent dust and debris from reentering main fluid flow 702 from collectors 701. As in collector 207 of FIG. 2, a higher pressure is developed within collectors 701 than in fluid flow 702. This pressure differential maintains the turning path of fluid flow 702 without impeding dust and debris 704 from being expelled into collectors 701. Also, circulating fluid flow 705 may develop within collectors 701. To prevent this, collectors 701 may comprise baffles (not shown) to inhibit fluid circulation within collectors 701. Because dust particles remaining in fluid flow 702 decrease in size after each redirection, the width of each subsequent slot 703 may also decrease in size. This minimizes energy losses from the mixing of fluid flow 702 with fluid in collectors 701. Additionally, protective lips 706 may be provided for slots 703 such that dust and debris do not reenter fluid flow 702.

A complete dust separator of this embodiment of the present invention may comprise many sections 700 connected in a series. Separators in accordance with this embodiment of the present invention effectively separate fine dust particles from fluid flow. Like the embodiment disclosed in FIG. 5, an arbitrarily large cross-section may be provided by increasing the height of the partitions while maintaining a small radii of curvature.

Ideally, the angle of curvature is 180°. Because of the geometry of multistage separators of the present invention, the angle of curvature is generally smaller (often between 120° and 130°). Preferably, folded dust separators of the present invention redirect fluid flow at angles approaching 180°. Further, radii of curvature are preferably between 0.1″ to 0.2″, although they may be smaller or larger if desired. However, the present invention is capable of maintaining smaller radii of curvature than cyclonic separators for any given flowrate. Consequently, under identical conditions, the folded dust separators of the present invention can more effectively separate particles from any magnitude of fluid flow than conventional dust separators can.

The folded dust separator of FIG. 7 creates an elongated path through which fluid must travel. In certain circumstances, the distance which fluid must travel is preferably minimized. FIG. 8 illustrates ripple separator 800 of the present invention providing such a “minimized” distance. Advantageously, ripple separator 800 can be constructed smaller, to reduce flow resistance, and more efficiently deflect finer particles from the fluid stream. The name “ripple” is used because the shape of the resultant flow path. As in previous embodiments, ripple separator 800 is partitioned into multiple collectors 801 via partitions 802. At the ends of partitions 802 are deflectors 803. During operation, fluid flow 804 is guided by deflectors 803 through ripple separator 800. Each time fluid flow 804 is redirected by deflectors 804, dust and debris 805 are ejected against deflectors 804. Subsequently, dust and debris 805 bounce off of deflectors 803 into collectors 801. Ultimately, separated dust and debris 806 remain within collectors 801 as fluid flow continues throughout ripple separator 800. Importantly, courser separated dust and debris 806 are removed into collectors 801 that are closer to the entrance (i.e., the left side). Finer separated dust and debris 806 are removed in collectors 801 further along the path of fluid flow 804 (i.e., to the right). Therefore, increasing the number of deflectors 803, partitions 802, and collectors 801 will increase the level of separation achieved by this system.

While in use, dust and debris 805 may adhere, or clump, to deflectors 803 or partitions 802. In the case that dust and debris 805 do not adhere or clump to partitions 802, dust and debris 805 may bounce around within collectors 801 and possibly reenter fluid flow 804. To prevent such occurrences, collectors 801 may be enlarged, or baffles (not shown) may be implemented to slow down fluid and dust movement within collectors 801. The baffles may comprise one or more plates disposed within collectors 801. Alternatively, electrostatically charged members may be disposed within collectors 801 to attract dust and debris 805. Partitions 802 may also be electrostatically charged for attracting dust and debris 805.

Furthermore, the separators of the present invention are not only capable of separating dust from fluid flow. Larger matter such as dirt, sand, etc., can also be separated using the separators of the present invention. Additionally, separators of the present invention can separate matter from a variety of fluids, both liquids and gases.

Additional modifications may be made to a ripple flow separator of the present invention to enhance dust and debris collection. FIG. 15 illustrates ripple separator 1500, which is the preferred ripple separator of the present invention. As in previous embodiments, fluid flow 1501 is deflected by deflectors 1502. During deflection, fluid flow ejects dust and debris into collectors 1503.

While in use, dust and debris may adhere, or clump, to deflectors 1502 or partitions 1504. In the case that dust and debris do not adhere or clump to partitions 1504, the dust and debris may bounce around within collectors 1503 and possibly reenter fluid flow 1501. To prevent such occurrences, collectors 1503 may be enlarged, or baffles 1505 may be implemented to slow down fluid, dust, and debris movement within collectors 1503. Alternatively, electrostatically charged members may be disposed within collectors 1503 to attract dust and debris. For instance, baffles 1505 or partitions 1504 may be electrostatically charged for attracting dust and debris.

Moreover, to aid in the collection of dust and debris, deflectors 1502 may be curved in the upstream direction as shown in FIG. 15. This prevents escape of the dust and debris while guiding it into collectors 1503.

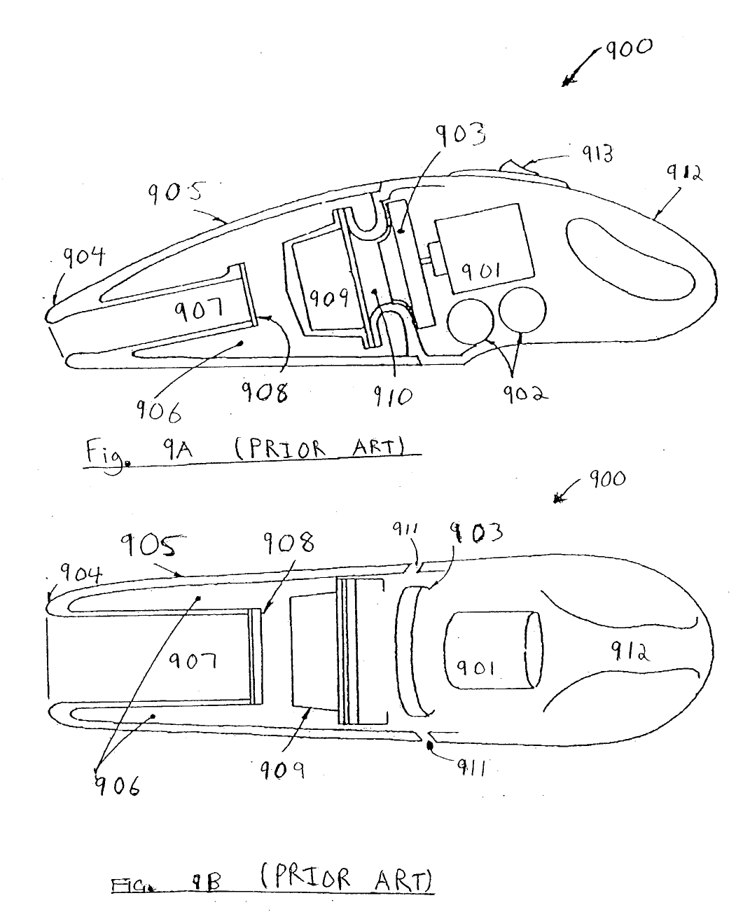

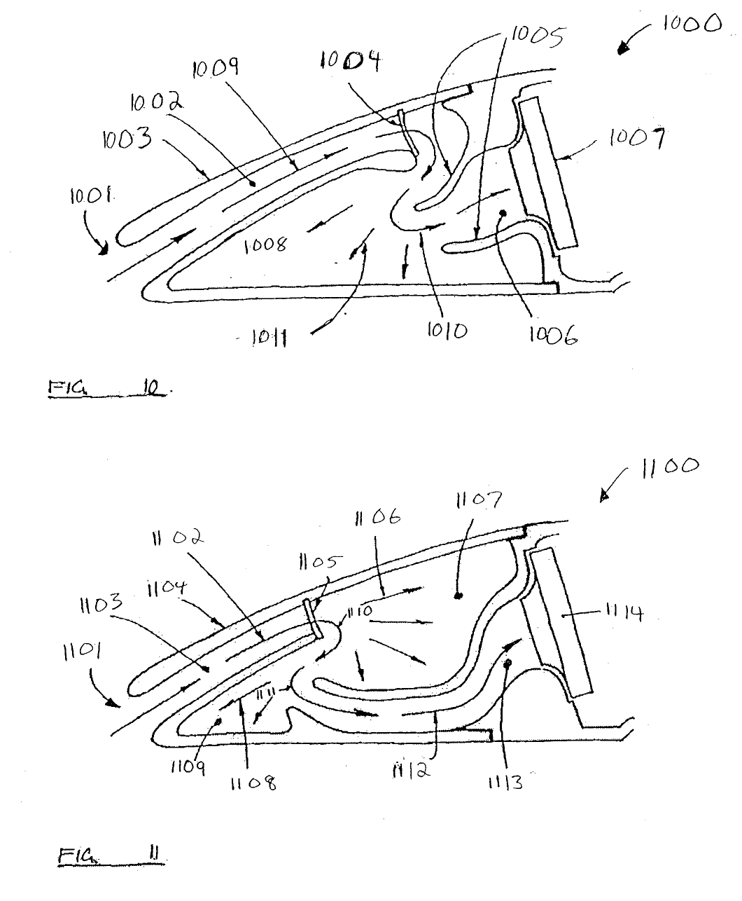

Up to this point, separators have been discussed which may be used for any number of applications without departing from the scope of the present invention. One such application is a portable vacuum cleaner. Horizontal and vertical cross-sections of a conventional portable vacuum cleaner are depicted in FIGS. 9A and 9B, respectively. Particularly, portable vacuum cleaner 900, fitted with handle 912 and power switch 913, utilizes motor 901 powered by batteries 902. Motor 901 drives a centrifugal pump impeller 903 such that air is taken into nozzle 904 formed within removable snout 905. Additionally, removable snout 905 acts as a debris collector by holding debris in dust collection area 906. Within removable snout 905, input duct 907 is constructed with rubber flap 908 at the proximal end. When motor 901 is running and air is being sucked into input duct 907, rubber flap 908 bends toward centrifugal pump impeller 903 allowing air to flow through the system. When motor 901 is off, however, rubber flap 908 seals input duct 907 preventing debris from falling out of portable vacuum cleaner 900.

During use, air flows directly from input duct 907 and through filter 909. As the dirty air flows through filter 909, the debris is captured while cleaned air continues onward through air venturi 910. After passing through centrifugal pump impeller 903, air is ejected out air outlets 911.

When the power is turned off and vacuum cleaner 900 is held with nozzle 904 down, some of the captured dirt falls into dust collection area 906. However, a considerable amount of dirt remains lodged in filter 909 which quickly becomes clogged. Furthermore, filters impede airflow requiring additional power to move air through the system. The present invention advances by sufficiently cleaning fluid flow without the use of a filter.

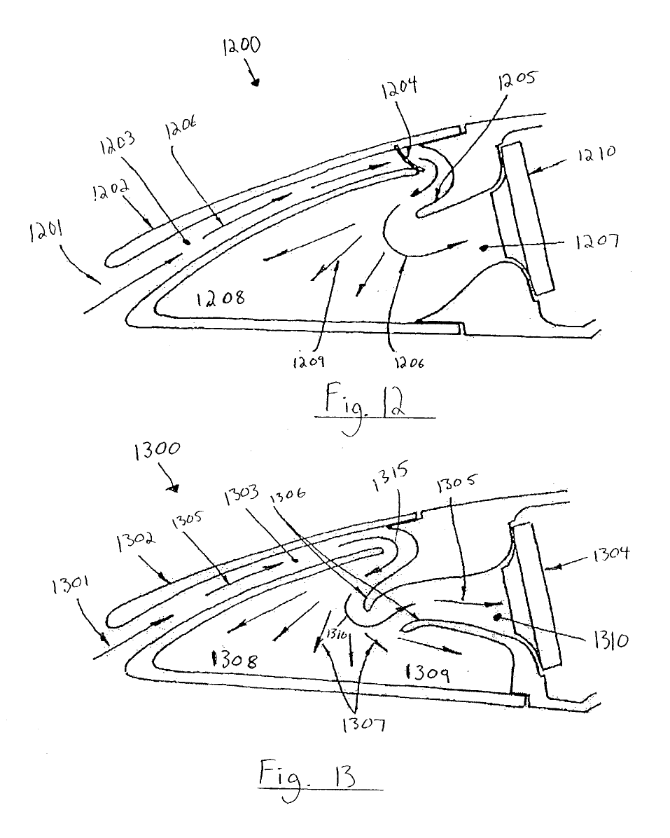

FIG. 10 depicts a vertical cross-section of portable vacuum cleaner 1000 of the present invention. Here, nozzle 1001 and input duct 1002 are formed within snout 1003. The proximal end of input duct 1002 is terminated with rubber flap 1004. In order to permit inflow, rubber flap 1004 bends inward unblocking the proximal end of input duct 1002. Projecting within snout 1003 are guide vanes 1005. These guide vanes 1005 are used to properly direct fluid flow for removal of dust and debris. At the proximal end of snout 1003, is venturi 1006 that leads into centrifugal impeller pump 1007. Additionally, snout 1003 is shaped to comprise collector 1008 for storing separated dust and debris. Optionally, snout 1003 may be detachable such that dirt and debris can be easily removed.

In operation, dirty fluid 1009 enters nozzle 1001 and flows through input duct 1002. While the motor is in operation, rubber flap 1004 is sucked in such that dirty fluid 1009 may flow by it. Then, fluid flow is guided by guide vanes 1005 in curved path 1010. While fluid flow follows curved path 1010, dense dust and debris 1011 continue straight into collector 1008. Thus, dust and debris are centrifugally removed from the fluid flow. Importantly, the pressure in collector 1008 is greater than the pressure along curved path 1010. The resulting pressure differential pushes fluid flow into its curved path 1010 without preventing higher mass dust and debris 1011 from traveling straight into collector 1008. Additionally, collector 1008 may comprises baffles (not shown) or to prevent mixing of fluid within collector 1008 and fluid flow 1010. Furthermore, collector 1008 may comprise electrostatically charged members to attract dust and debris 1011. This prevents the formation of parasitic eddies and improves overall efficiency. Subsequent to separation, fluid flow is directed through venturi 1006 and centrifugal pump impeller 1007. Then the fluid may be ejected.

Significantly, guide vanes 1005 and collector 1008 form a single stage of a folded dust separator. This single stage method more effectively separates dirt and debris than conventional vacuum cleaner bags and filters. Moreover, clogging of bags and filters is successfully avoided.

By devising alternative guide vane arrangements, a multistage folded separator can be fitted into the vacuum cleaner snout. Portable vacuum cleaner 1100 of the present invention, shown in FIG. 11, illustrates a two-stage system. Dirty air 1102 enters detachable snout 1104 through nozzle 1101 into input duct 1103 and passes by rubber flap 1105 similarly to the embodiment of FIG. 10. Fluid flow is immediately redirected along curved path 1110 causing dust and debris 1106 to be thrown into the first collector 1107. The fluid flow is then redirected a second time along curved path 1111 such that a second dust separation occurs and finer, remaining dust and debris 1108 exit into second collector 1109. As in the embodiment of FIG. 11, cleaned fluid flow 1112 is smoothly guided to through centrifugal pump impeller 1114 via venturi 1113. In both first collector 1107 and second collector 1109, the pressure is higher than in curved paths 1110 and 1111, respectively. As stated supra, the curved fluid flow is maintained by these higher pressures without inhibiting dust from carrying into first collector 1107 and second collector 1109. First collector 1107 and second collector 1109 may also comprise baffles to maximize efficiency, as indicated for the embodiment of FIG. 10. Moreover, the embodiment of FIG. 11 may comprise any and all of the additional features indicated for the embodiment of FIG. 10.

Alternatively, the separation process and the corresponding structure included within portable vacuum cleaners of the present invention may effect an arbitrary number of additional stages. Thus, any desired level of separation may be achieved by configuring guide vanes for additional stages of separation. As outlined supra, the throughput of the present invention can be increased without comprising the flow dynamics and efficiency of the system.

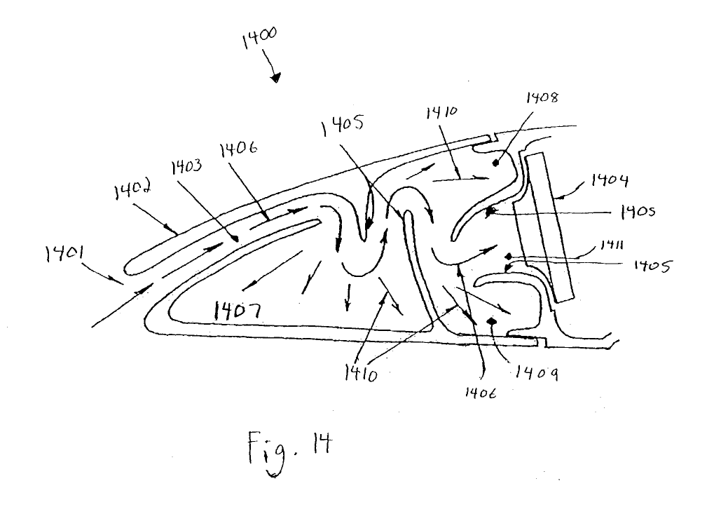

Alternatively, portable vacuum cleaners of the present invention can be constructed as shown in FIGS. 12 and 13. FIG. 12 illustrates an alternative embodiment of a portable vacuum cleaner with a single collector. Portable vacuum cleaner 1200 comprises nozzle 1201, snout 1202, input duct 1203, rubber flap 1204, and centrifugal pump impeller 1210 similar to the embodiments of FIGS. 10 and 11. However, single guide vane 1205 is used to guide fluid flow 1206 through the system. Fluid flow 1206 is redirected into venturi 1207 by high pressure in collector 1208. During redirection, dust and debris 1209 flow into collector 1208. Baffles or electrostatically charged members (not shown) may be included within the dust box to prevent dust and debris 1209 from reentering fluid flow 1206. Finally, cleaned fluid flow 1206 exits via centrifugal pump impeller 1210.

With reference to FIG. 13, portable vacuum cleaner 1300 comprises nozzle 1301, snout 1302, input duct 1303, and centrifugal pump 1304 as described in previous embodiments. The system may also comprise a rubber flap (not shown). Fluid flow 1305 is directed through the system by guide vanes 1306. Through pressure guided redirection, dust and debris 1307 are ejected into collectors 1308 and 1309. Upon a first redirection along path 1315, dust and debris 1307 are expelled into collector 1308. During the second redirection along path 1316, dust and debris 1307 are expelled into collector 1309. Collectors 1308 and 1309 may be separated by a partition (not shown) or left open to each other as shown. With no such partition, all dust and debris 1307 is free to fall into collector 1308 when portable vacuum cleaner 1300 is turned off and hung nozzle down. Additionally, collectors 1308 and 1309 may contain baffles or electrostatically charged members (not shown). Finally, cleaned fluid flow 1306 is ejected from the system via venturi 1310 and centrifugal impeller pump 1304. Also, snout 1302 may be constructed to be detachable.

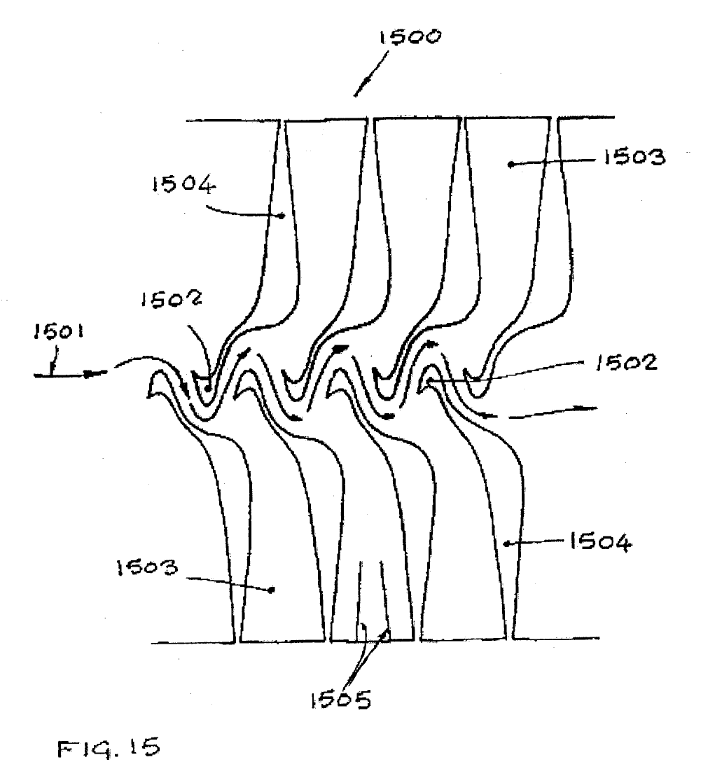

In the preferred vacuum cleaner of the present invention, portable vacuum cleaner 1400 of the present invention may be constructed with three sections as disclosed in FIG. 14. As disclosed in previous embodiments, portable dust separator 1400 comprises nozzle 1401, snout 1402, input duct 1403, and centrifugal pump impeller 1404. A rubber flap (not shown) may also be implemented. Guide vanes 1405 of this embodiment guide fluid flow 1406 into three separation steps utilizing collectors 1407, 1408, and 1409. High pressure within these collectors redirects fluid flow 1406 three times throughout the system such that dust and debris 1410 are ejected into collectors 1407, 1408, and 1409. Once again, collectors 1407, 1408, and 1409 may comprise baffles or electrostatically charged members (not shown) to prevent dust or debris from reentering fluid flow 1406. Cleaned fluid flow 1406 exits the system via venturi 1411 and centrifugal pump impeller 1404. When the system is turned off and portable vacuum cleaner 1400 is held nozzle down, dust and debris 1410 will fall into collector 1407 without escaping from snout 1402. Further, snout 1402 can be made to be detachable.

In the embodiments disclosed herein, guide vanes are often attached to the body of the dust-buster (i.e., not the snout) so that when the snout is removed the dust and debris can be easily poured out. Alternatively, the guide vanes may be attached to the snout, or even removably attached to the snout. Thus, the body, guide vanes, and snout may be detached from one another in any combination for ease of cleaning and maintenance. Also, the portable vacuum cleaners of the present invention may also comprise, but are not limited to, a handle, batteries, a motor (which may be battery powered), a combustion engine, a light, an on/off switch, power adjustment means, and various other features without departing from the spirit of the present invention.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

I claim:

1. An apparatus for separating matter from fluid flow comprising a passage, wherein said passage redirects said fluid flow;
wherein upon redirection said matter is removed from said fluid flow;
and wherein said apparatus can be constructed such that the cross-sectional area of said fluid flow does not restrict the radius of curvature of said redirection.

2. An apparatus according to claim 1, wherein said passage comprises at least one deflector.

3. An apparatus according to claim 2, wherein said deflector is curved in the upstream direction to prevent said matter from reentering said fluid flow.

4. An apparatus according to claim 2, wherein said deflector deflects said matter from said fluid flow.

5. An apparatus according to claim 1, wherein said passage redirects fluid flow a plurality of times.

6. An apparatus according to claim 5, wherein the number of said times can be made sufficiently large to effect a desired level of separation of said matter from said fluid flow.

7. An apparatus according to claim 1, wherein said passage is formed by partitions.

8. An apparatus according to claim 1, wherein a dimension of said passage can be increased such that the cross-sectional area of said fluid flow is increased and the radius of curvature of said redirection is substantially unaffected.

9. An apparatus according to claim 1, wherein the radius of curvature of said redirection is sufficiently small to expel fine dust particles from said fluid flow.

10. An apparatus according to claim 1 further comprising at least one collector connected with said passage to collect said matter.

11. An apparatus according to claim 10 further comprising a slot that leads from said passage to said collector.

12. An apparatus according to claim 11, wherein said slot comprises a lip.

13. An apparatus according to claim 11, wherein said fluid flow is redirected a plurality of times;
and wherein said apparatus comprises a plurality of collectors and a plurality of corresponding slots connecting said passage to said collectors;
and wherein the width of said slots decreases with each subsequent redirection of said fluid flow.

14. An apparatus according to claim 10, wherein said collector comprises baffles to prevent circulation of said fluid flow.

15. An apparatus according to claim 10, wherein said collector prevents the formation of an eddy.

16. An apparatus according to claim 10, wherein a higher pressure is developed in said collector than in said fluid flow such that the redirecting characteristic of said fluid flow is maintained without preventing said matter from entering said collector.

17. An apparatus according to claim 1, wherein the angle of said redirection is less than 180°.

18. An apparatus for separating matter from fluid flow comprising:
a passage, wherein said passage redirects said fluid flow;
at least one collector; and
at least one slot providing an opening between said collector and said passage;
whereupon redirection of said fluid flow, said matter is ejected into said collector;
and wherein said apparatus can be constructed such that the cross-sectional area of said fluid flow does not restrict said radius of curvature.

19. An apparatus according to claim 18, wherein said passage comprises at least one deflector.

20. An apparatus according to claim 19, wherein said deflector is curved in the upstream direction to prevents said matter from reentering said fluid flow.

21. An apparatus according to claim 19, wherein said deflector deflects said matter into said collector.

22. An apparatus according to claim 18, wherein said passage redirects fluid flow a plurality of times.

23. An apparatus according to claim 22, wherein the number of said times can be made sufficiently large to effect a desired level of separation of said matter from said fluid flow.

24. An apparatus according to claim 18, wherein said passage is formed by partitions.

25. An apparatus according to claim 18, wherein a dimension of said passage can be increased such that the cross-sectional area of said fluid flow is increased and the radius of curvature of said redirection is substantially unaffected.

26. An apparatus according to claim 18, wherein the radius of curvature of said redirection is sufficiently small to expel fine dust particles from said fluid flow.

27. An apparatus according to claim 18, wherein said slot comprises a lip.

28. An apparatus according to claim 22, wherein said apparatus comprises a plurality of collectors and a plurality of corresponding slots connecting said passage with said collectors;
and wherein the width of said slots decreases with each subsequent redirection of said fluid flow.

29. An apparatus according to claim 18, wherein said collector comprises baffles to prevent circulation of said fluid flow.

30. An apparatus according to claim 18, wherein said collector prevents the formation of an eddy.

31. An apparatus according to claim 18, wherein a higher pressure is developed in said collector than in said fluid flow such that the redirecting characteristic of said fluid flow is maintained without preventing said matter from entering said collector.

32. An apparatus according to claim 18, wherein the angle of said redirection is less than 180°.

33. A method of removing matter from fluid flow comprising the steps of:
redirecting said fluid flow such that said matter is ejected from said fluid flow; and
collecting said matter such that said fluid flow continues with less of said matter;
wherein the cross-sectional area of said fluid flow does not restrict the radius of curvature of said redirecting.

34. A method according to claim 33, wherein said redirecting is performed a plurality of times.

35. A method according to claim 34, wherein the number of said times can be made sufficiently large to effect a desired level of separation of said matter from said fluid flow.

36. A method according to claim 33, wherein the cross-sectional area of said fluid flow can be increased while the radius of curvature of said redirection is substantially unaffected.

37. A method according to claim 33, wherein the radius of curvature of said redirection is sufficiently small to expel fine dust particles from said fluid flow.

38. A method in accordance with claim 33 further comprising the step of ejecting said matter into a collector.

39. A method according to claim 38 further comprising the step of preventing fluid flow in said collector.

40. A method according to claim 38 further comprising the step of preventing the formation an eddy in said collector.

41. A method according to claim 38 further comprising the step of developing a higher pressure in said collector than in said fluid flow such that the redirecting characteristic of said fluid flow is maintained without preventing said matter from entering said collector.

42. A method according to claim 33, wherein the angle of said redirection is less than 180°.

43. A method according to claim 33, wherein said collecting is facilitated by electrostatic attraction.

44. A method according to claim 33, wherein said matter is deflected from said fluid flow.

45. An apparatus comprising:
an entrance for fluid;
guide means that guides said fluid; and
fluid delivery means that effects flow of said fluid;
whereupon traveling through said guide means, said fluid flow is redirected, thereby expelling said matter therefrom;
and wherein said apparatus can be constructed such that the cross-sectional area of said fluid flow does not restrict the radius of curvature of said redirection.

46. An apparatus according to claim 45 further comprising a snout.

47. An apparatus according to claim 46, wherein said snout is detachable.

48. An apparatus according to claim 46, wherein said guide means is coupled to said snout.

49. An apparatus according to claim 46, wherein said guide means is detachably coupled to said snout.

50. An apparatus according to claim 45 further comprising a flap.

51. An apparatus according to claim 50, wherein said flap comprises rubber.

52. An apparatus according to claim 50, wherein said flap is opened when said fluid delivery means is on, and wherein said flap is closed when said fluid delivery means is off.

53. An apparatus according to claim 45 further comprising at least one collector for collecting said matter.

54. An apparatus according to claim 53, wherein the pressure in said collector is greater than the pressure in said fluid flow such that the redirecting path of said fluid flow is maintained while matter is still capable of entering said collector.

55. An apparatus according to claim 53, wherein said collector further comprises at least one baffle.

56. An apparatus according to claim 53, wherein said collector comprises at least one electrostatically charged member.

57. An apparatus according to claim 45 further comprising a member selected from the group consisting of a venturi, a light, a handle, an input duct, and an on/off switch.

58. An apparatus according to claim 45, wherein said fluid delivery means is a centrifugal pump impeller.

59. An apparatus according to claim 45, wherein said fluid delivery means comprises a feature selected from the group consisting of a motor, a combustion motor, an electric motor, a battery-powered motor, and mechanical input.

60. An apparatus according to claim 45, wherein the power of said fluid delivery means is adjustable.

61. An apparatus according to claim 45, wherein said fluid flow is redirected a plurality of times.

62. An apparatus according to claim 45, wherein said entrance is a nozzle.

63. An apparatus according to claim 45, wherein said guide means comprises one or more guide vanes.

64. An apparatus comprising:
a nozzle through which fluid may enter;
fluid delivery means that effects flow of said fluid;
at least one guide vane that guides said fluid flow; and
at least one collector;
whereupon traveling through said guide means, said fluid flow is redirected, thereby expelling matter from said fluid flow into said collector;
and wherein the pressure in said collector is greater than the pressure in said fluid flow such that the redirecting path of said fluid flow is maintained while matter is still capable of entering said collector;
and wherein said apparatus can be constructed such that the cross-sectional area of said fluid flow does not restrict the radius of curvature of said redirection.

65. An apparatus according to claim 64, wherein said collector comprises at least one baffle.

66. An apparatus according to claim 64, wherein said collector comprises at least one electrostatically charged member.

67. An apparatus according to claim 64 further comprising a snout.

68. An apparatus according to claim 67, wherein said snout is detachable.

69. An apparatus according to claim 67, wherein is guide vane is coupled to said snout.

70. An apparatus according to claim 67, wherein said guide vane is detachably coupled to said snout.

71. An apparatus according to claim 64 further comprising a flap.

72. An apparatus according to claim 71, wherein said flap comprises rubber.

73. An apparatus according to claim 71, wherein said flap is opened when said fluid delivery means is on, and further wherein said flap is closed when said fluid delivery means is off.

74. An apparatus according to claim 64 further comprising a member selected from the group consisting of a venturi, a light, a handle, an inlet duct, and an on/off switch.

75. An apparatus according to claim 64, wherein said fluid delivery means is a centrifugal pump impeller.

76. An apparatus according to claim 64, wherein said fluid delivery means comprises a feature selected from the group consisting of a motor, a combustion motor, an electric motor, a battery-powered motor, and mechanical input.

77. An apparatus according to claim 64, wherein the power of said fluid delivery means is adjustable.

78. An apparatus according to claim 64, wherein said fluid flow is redirected a plurality of times.

79. A method for separating matter from fluid comprising the steps of:
moving fluid flow through a system;
redirecting said fluid flow at least one time, whereupon said redirecting, said fluid flow ejects said matter into a collector; and
creating a higher pressure in said collector than in said fluid flow such that the redirecting path of said fluid flow is maintained while matter is still capable of entering said collector;
and wherein the cross-sectional area of said fluid flow does not restrict the radius of curvature of said redirecting.

80. A method according to claim 79, wherein said redirecting occurs a plurality of times.

81. A method according to claim 79, wherein said fluid flow moves a flap such that fluid may flow through said system, and whereupon the termination of said fluid flow, said flap seals said collector such that said ejected matter is contained therein.

82. A method according to claim 79 further comprising the step of electrostatically attracting said matter.

83. A method according to claim 79 further comprising the step of preventing circulation of said fluid flow in said collector.
